(19) United States
(12) Patent Application Publication
(10) Pub. No.: US 2014/0172522 A1
(43) Pub. Date: Jun. 19, 2014

(54) TRANSACTION METHOD AND APPARATUS

(71) Applicant: Glen Moore, Hertfordshire (GB)

(72) Inventor: Glen Moore, Hertfordshire (GB)

(21) Appl. No.: 13/718,849

(22) Filed: Dec. 18, 2012

(51) Int. Cl. G06Q 30/06

(52) U.S. Cl. CPC G06Q 30/0613
USPC 705/14.1; 705/26.3; 705/26.41

(57) ABSTRACT

A method of facilitating transactions between a first party and a second party. The method comprises, receiving from the first party a first indication of interest for the transaction subject, generating a response and an response reveal date in response to receiving the first indication of interest, and transmitting the response to the first party on or after the response reveal date.

The present invention relates to methods for facilitating transactions between two parties.

In retail, it is generally beneficial to sell a product or service to all customers who are willing to pay more than the marginal cost of providing that product or service, at the maximum price each customer is willing to pay. In practice, however, this is difficult to achieve. For example, customers who know that a retailer is willing to sell a product or service to another customer at a particular price may be unwilling to pay a higher price for the same product or service.

To overcome this, some retailers employ differential pricing policies, whereby the same, or similar, products or services can be sold at different prices to different groups of customers, based upon particular dividing criteria. For example, a train operator may offer discounts to students or pensioners, airlines may adjust the price of a particular flight as tickets for that plane sell, and manufacturers may use “versioning” (where the differences in the prices of products within a range are not proportional to the differences in their marginal costs of production) to provide a range of different products encompassing a range of price points. For example, toothpaste may be provided with or without fluoride, with or without whitening agents, etc.

The differential pricing policies currently employed, however, operate at a relatively coarse granularity and, as such, cannot provide a price point for all potential buyers of a product or service. Additionally, the differential pricing policies currently employed necessarily require considerable additional expenditure and effort beyond that required to offer a single product or service. Further, each of the above approaches generally works only for manufacturers or service providers, making it difficult for retailers to utilise differential pricing directly in their interactions with their customers.

It is an object of at least one embodiment of the present invention to obviate or mitigate one or more of the problems encountered in the prior art, whether identified herein or elsewhere.

### SUMMARY

According to a first aspect of the present invention, there is provided a computer implemented method of facilitating transactions between a first party and a second party, comprising: receiving from the first party a first indication of interest in a transaction subject; generating, in response to receiving the first indication of interest, a response and a response reveal date; and transmitting the response to the first party on or after the response reveal date.

The first transaction subject may be, for example, a product or a service offered for sale by the second party. The first aspect therefore provides a method by which the first party can negotiate over a price of the transaction subject without requiring the second party to provide individual negotiation with the first party; thereby reducing associated expenditure and inconvenience. Due to the generation and use of a response reveal date, however, it appears to the first party that he is engaged in a personal negotiation with the second party.

The response reveal date may comprise either a date, a time or both a date and a time. In this way, aspects of the present invention can generate the response reveal dates based on dates and/or times of day at which the first party is most likely to engage in transactions. For example, the method may comprise evaluating historical data related to the first party to determine, e.g., a time of day or days of the week on which the customer is most likely to transact. Such historical information may be, for example, dates and times at which the first party has previously engaged with the second party, or dates and times at which the first party has previously transacted with the second party.

In some embodiments, the response may include an offer price. At least one of the offer price or response reveal date may be generated using one or more artificial intelligence techniques. For example, at least one of the offer price or response reveal date may be generated using a neural network. In this way, such a neural network may be trained to generate offer prices (based on the previous behaviour of the first party or of other parties with whom the system determines it is correct to draw a parallel) which are expected to be accepted, over the period of the negotiation, in response to the indication of interest received from the first party, and/or offer reveal dates on which those prices are more likely to be accepted, and/or more likely to provide a convincing effect of personal negotiation.

Generating at least one of the response reveal date or offer price may comprise applying a randomising factor. In this way, a more convincing effect of negotiating with the second party is achieved.

The response reveal date and/or the offer price may be generated based upon first transaction criteria associated with the transaction subject. The first transaction criteria may comprise at least one of a maximum discount to be applied to the transaction subject, a maximum discount to be applied across a plurality of transaction subjects, and a target discount to be applied across the plurality of transaction subjects. In this way, the offer price can be efficiently and expediently calculated according to requirements set by the second party, without the second party needing to provide input for each negotiation with the first party. The first transaction data may also comprise ‘live’ and historical data recording previous behaviours of the first party and other parties.

The first indication of interest may comprise a first bid, the first bid comprising a bid price; and generating at least one of the offer price or response reveal date may comprise processing the bid price to generate the offer price and/or response reveal date. In this way, the generation of the offer price and/or response reveal date may be customized to the particular bid received from the first party, thereby improving the effect that the first party is negotiating with the second party.

The first indication of interest may comprise a bid duration comprising a time period for which the first bid is executable by the second party, and the generation of the offer price and/or offer reveal date may be based upon the bid duration.

Generating at least one of an offer price and/or a response reveal date further may comprise processing at least one of: a bid price received from the first party, a bid expiry date received from the first party, an original price of the transaction subject, a number of items of the transaction product sold in prior transactions, an average discount applied to items of the transaction subject in prior transactions, a maximum discount to be applied to the transaction subject, a maximum average discount to be applied to a plurality of transaction subjects, values of previously received bid prices, values of previously generated offer prices, a number of previously received bid prices from the first party for the transaction subject, information acquired from parties not engaged in said transaction, and one or more randomising factors to generate the offer price and/or the response reveal date.

Generating at least one of an offer price and a response reveal date further may comprise providing at least one of: a bid price received from the first party, a bid expiry date received from the first party, an original price of the transaction subject, a number of items of the transaction product sold in prior transactions, an average discount applied to items of the transaction subject in prior transactions, a maximum discount to be applied to the transaction subject, a maximum average discount to be applied to a plurality of transaction subjects, values of previously received bid prices, values of previously generated offer prices, a number of previously received bid prices from the first party for the transaction subject, information acquired from parties not engaged in said transaction, and one or more randomising factors as inputs to a neural network.

For example, information from parties not engaged in the transaction may include historical information relating to other parties interactions with the second party, and/or information obtained from external websites (for example, “blogs”, news, weather, sporting websites, etc).

The first indication of interest may comprise a bid price; the response may comprise an indication of acceptance of the bid price. In this way, a counter offer is not provided to the first party, where the bid price is acceptable.

The first indication of interest may comprise a bid price, and the response may comprise an indication of rejection of the bid price to the first party. For example, where it is not desired to receive further bids, a bid received from the first party may result in a rejection. This may occur for example, where a number of prior bids have already been received from the first party for the transaction subject. A number of allowed bids may be set by the second party, or by a third party, where the second party is acting on behalf of the third party.

The method may further comprise receiving a respective first indication of interest in the transaction subject from each one of a plurality of first parties, each of the respective indications of interest comprising a respective bid price; and processing the respective bid prices to generate a depth of market indication. By depth of market, it is meant an indication of a number of items of the transaction subject that would have sold at particular prices, as determined by the respective bid prices. In this way, the second party is provided with useful information even in the event that a transaction does not result in sale of the transaction subject. The second party may then use this information to adjust prices of the transaction subject. The second party may then provide further transaction criteria for the transaction subject. This visible depth of market allows the second party to measure the extent to which he would have to reduce his price on order to generate a certain number of transactions instantly. This may be useful, for example, should the second party wish to increase sales volume of the transaction subject in order to qualify for a tiered discount available from a manufacturer (or distributor) or, to increase cash flow.

Transmitting the response to the first party on or after the response reveal date may comprise transmitting the response over a secure medium. For example, a secure web-page may be provided for the communication of the offer price. The secure medium may be inaccessible by indexing mechanisms of network search engines. In these ways, rival parties are unable to use prices offered by the second party, for the transaction subject to adjust prices offered by the rival parties for the same or similar transaction subjects.

The first indication of interest may comprise a bid and the method further may comprise determining whether a predetermined number of bids have been received for the transaction subject from the first party; and if it is determined that the predetermined number of bids have been received for the transaction subject from the first party, disallowing receipt of further bids for the transaction subject from the first party. In this way, the first party may be motivated to provide bids comprising more favourable bid prices and discouraged from offering overly speculative and undervalued bid prices.

Transmitting an indication of the offer price to the first party may comprise transmitting an indication of a number of items of the transaction subject available for purchase by the first party at an offer price. For example, for reduced offer prices, a reduced number of items of the transaction subject may be offered for purchase by the first party. This has a number of benefits. For example, the first party may be motivated to purchase at a higher offer price in the knowledge that there may be insufficient items of the transaction subject available at lower offer prices. The number of items may be dependent upon a membership level of the first party.

The method may further comprise reducing the number of items available for purchase by the first party at the offer price upon purchase of an item of the transaction subject by a fourth party at the offer price and providing an indication of the reduced number of items to the first party.

The method may further comprise, in response to receiving the indication of interest, reducing a previously available number of items of the transaction subject available for purchase by the first party; and wherein said first response comprises an indication of the reduced number of items of the transaction subject available for purchase by the first party.

The receiving, generating and transmitting may be carried out at a third party, distinct from said second party. The transaction criteria may be received at the third party from the second party. In this way, the second party may act on behalf of the third party.

According to a second aspect of the present invention, there is provided a computer implemented method for facilitating transactions between a first computer and a second computer, comprising; receiving over a first network from the first computer a first indication of interest in a transaction subject; generating, in response to receiving the first indication of interest, a response and a response reveal date; and transmitting over the first network the response to the first computer on or after the response reveal date.

The receiving, generating and transmitting may be performed by a third computer distinct from the first and second computer. Transaction criteria may be received over a second network from the second computer at the third computer. The first network and the second network may be the same network. For example, the first network and the second network may both be the Internet. Alternatively, or additionally, the first network may comprise a secure network between the second party and the third party. For example, the first network may comprise a VPN, or similar private network.

According to a third aspect of the present invention, there is provided a system for facilitating transactions between a first computer and a second computer, comprising; a first receiver arranged to receive over a first network from the first computer a first indication of interest in a transaction subject; a processor arranged to generate, in response to receiving said first indication of interest, a response and a response reveal date; and a transmitter arranged to transmit over the first network the response to the first computer on or after the response reveal date.

It will be appreciated that aspects of the present invention can be implemented in any convenient way including by way of suitable hardware and/or software. For example, a device arranged to implement the invention may be created using appropriate hardware components. Alternatively, a programmable device may be programmed to implement embodiments of the invention. The invention therefore also provides suitable computer programs for implementing aspects of the invention. Such computer programs can be carried on suitable carrier media including tangible carrier media (e.g. hard disks, CD ROMs and so on) and intangible carrier media such as communications signals.

One or more aspects of the invention may, where appropriate to one skilled in the art, be combined with any one or more other aspects described herein, and/or with any one or more features described herein.

### BRIEF DESCRIPTION OF DRAWINGS

Embodiments of the present invention are now described, by way of example only, with reference to the accompanying drawings, in which:

FIG. 1 is a schematic illustration of a network of communicating entities in some embodiments of the present invention;

FIG. 2 is a schematic illustration of components of a computer suitable for implementing at least one of the entities of FIG. 1;

FIG. 3 is a schematic illustration of tables in a database of FIG. 1;

FIG. 4a is a flowchart illustrating processing that may be carried out by a facilitator of FIG. 1 to facilitate transactions between a retailer and a customer of FIG. 1;

FIG. 4b is another flowchart illustrating further processing that may be carried out by a facilitator of FIG. 1 to facilitate transactions between a retailer and a customer of FIG. 1,

FIG. 5 is a flowchart illustrating processing that may be carried out by a facilitator on an offer reveal date; and

FIG. 6 is a flowchart illustrating further processing that may be carried out by a facilitator on an offer reveal date.

### DETAILED DESCRIPTION

In general, the present invention is concerned with methods and systems to allow two parties (for example, a business and a customer) to negotiate effectively over the price of items for sale by one of the parties. More particularly, the present invention provides methods and systems which reduce an amount of work necessary by one party to participate in negotiations, while still providing, for the other party, the effect and experience of negotiating in real-time with the other party.

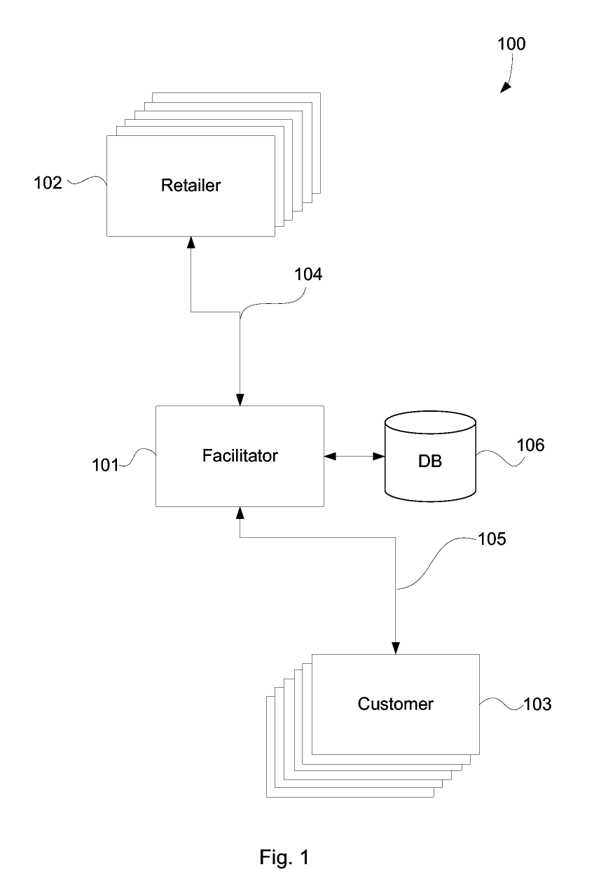

FIG. 1 schematically illustrates components of embodiments of the present invention in the form of a network 100. The network 100 comprises a facilitator 101, a plurality of retailers 102, and a plurality of customers 103. Each of the plurality of retailers 102 is connected to the facilitator 101 (those connections being represented in FIG. 1 by a bidirectional arrow 104). Similarly, each of the customers 103 is connected to the facilitator 101, (those connections being represented by a bidirectional arrow 105). The facilitator is connected to a database 106. While illustrated in FIG. 1 as direct connections, the connections 104, 105 may be any appropriate connections. For example, the connections 104, 105 may be through a network such as the Internet.

It is to be understood that the facilitator 101, each of the customers 103 and each of the retailers 102 each comprise both an entity (e.g. a person, or company, etc) and an appropriately programmed computer, connected via the connections 104, 105.

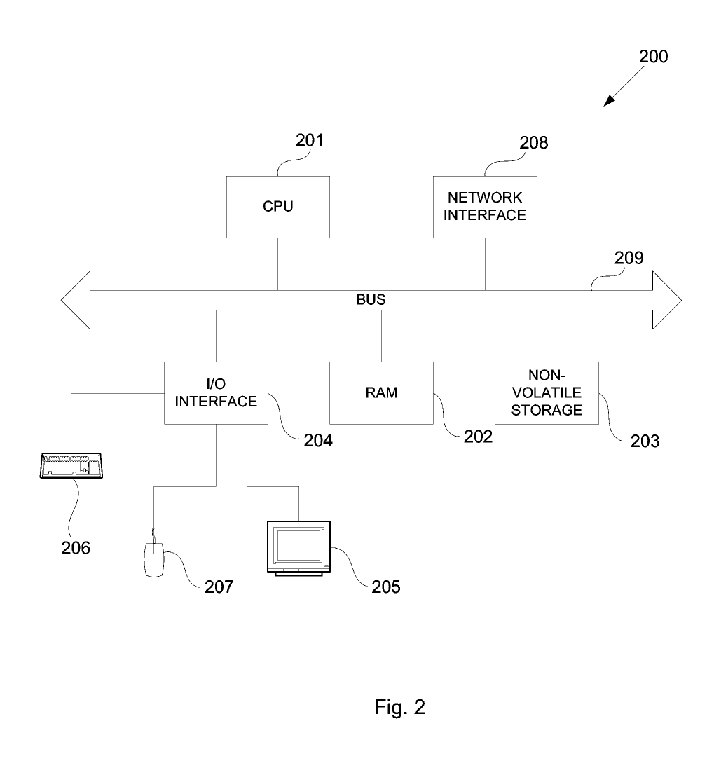

Referring to FIG. 2 there is shown a schematic illustration of components of a computer 200 which can be used to implement the facilitator 101 in accordance with some embodiments of the present invention. It can be seen that the computer 200 comprises a CPU 201 which is configured to read and execute instructions stored in a volatile memory 202 which takes the form of a random access memory. The volatile memory 202 stores instructions for execution by the CPU 201 and data used by those instructions.

The computer 200 further comprises non-volatile storage 203. For example, the non-volatile storage 203 may be in the form of a hard disc drive, or a solid state drive such as a Flash drive. In some embodiments, the database 106 may be stored on the non-volatile storage 203. It will be appreciated, however, that the database 106 may be stored on a separate computer providing a database server. The computer 200 further comprises an I/O interface 204 to which are connected peripheral devices used in connection with the computer 200. More particularly, a display 205 is configured so as to display output from the computer 200. Input devices are also connected to the I/O interface 204. Such input devices include a keyboard 206 and a mouse 207 which allow user interaction with the computer 200. A network interface 208 allows the computer 200 to be connected to an appropriate computer network so as to receive and transmit data from and to other computing devices, for example, computer terminals of the retailers 102 and the customers 103. The CPU 201, volatile memory 202, non-volatile memory 203, I/O interface 204, and network interface 208, are connected together by a bus 209.

It will be appreciated that the arrangement of components illustrated in FIG. 2 is merely exemplary, and that the facilitator 101 may comprise additional or fewer components than those illustrated in FIG. 2. Indeed, the facilitator 101 may comprise a plurality of computers, similar to, or arranged differently from, the computer 201. For example, the facilitator 101 may comprise a plurality of computers respectively adapted to provide, inter alia, a web server, an application server, and a database server. That is, it is to be understood that the facilitator 101 may be implemented using any appropriate configuration as will be readily appreciated by those skilled in the art. It will also be appreciated that the retailers 102 and the customers 103 may each comprise computers implemented similarly to the computer 200, or again using any appropriate configuration.

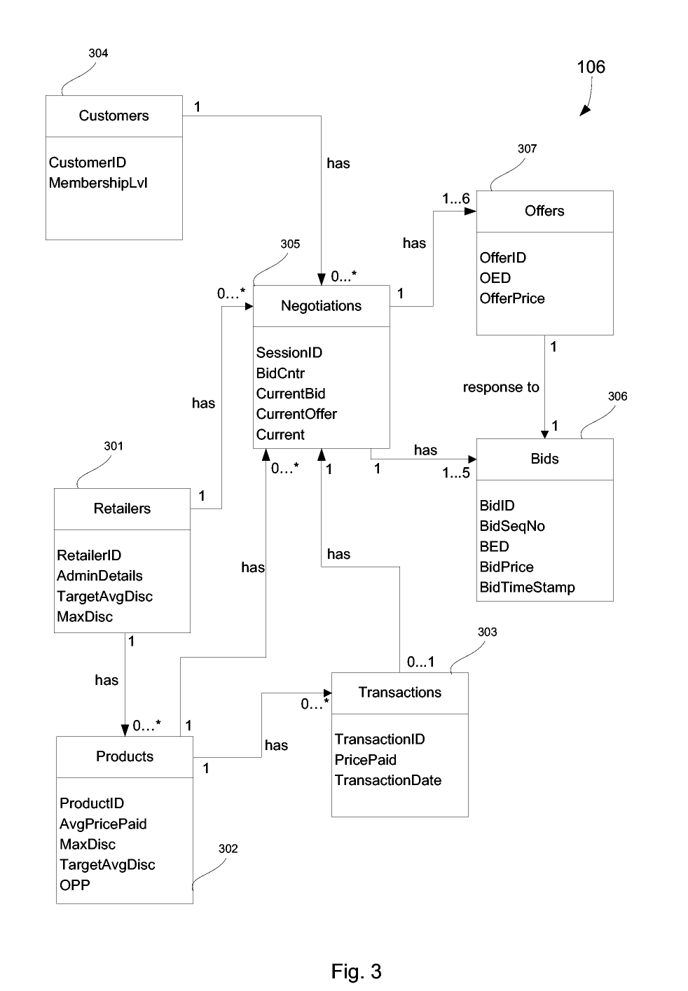

Referring now to FIG. 3, there is schematically depicted relationships between tables of the database 106 in accordance with some embodiments of the present invention. Throughout the description of FIG. 3 below, it is to be understood that the tables and relationships depicted are exemplary. As such, it will be appreciated that the database 106 may comprise different, or additional tables, to those shown in FIG. 3. Similarly, the tables shown in FIG. 3 and described below may comprise different or additional fields to those shown in FIG. 3.

A Retailers table 301 stores a unique record for each of the retailers 102. The Retailers table 301 comprises a TargetAveDisc field, a MaxDisc field, and a RetailerID field. In each record of the Retailers table 301, the RetailerID field uniquely identifies the respective retailer 102, while for each retailer 102, the TargetAveDisc field stores data indicating a targeted average discount across all products sold by the retailer 102 through the facilitator 101. That is, the target average discount field specifies the average discount that the retailer would like to achieve across all of the products sold by the retailer 102 through the facilitator 101. The MaxDisc field indicates a maximum discount that a retailer would like to offer across all products sold through the facilitator 101.

Each retailer 102 may have zero or more products for sale, and therefore zero or more corresponding entries in a Products table 302. Each entry in the Products table 302 corresponds to a product offered for sale by a retailer 102 through the facilitator 101. The Products table 302 comprises a ProductID field, an AvePricePaid field, a MaxDisc field, a TargetAvgDisc field and an OPP field. For each product offered for sale by a retailer 102 through the facilitator 101, the ProductID field uniquely identifies the product in the database 106. The AvePricePaid field stores data indicating the average price paid by customers 103 who have purchased the product through the facilitator 101. The MaxDisc field records a maximum discount acceptable to the retailer 102 for that product, which can be applied by the facilitator 101 in negotiations with customers 103. That is, the retailer may not sell that product for a discount greater than the discount stored in the MaxDisc field of the corresponding product. For a particular product, the TargetAveDisc field records a target average discount that the facilitator 101 should aim to achieve in transactions with customers 103 for that product. The target average discount is a “target” because, as described below, the generation of offer prices may comprise a random element. As such, it is conceivable that a retailer 102 ceases offering a product through the facilitator 101 at a time at which the average discount at which that product has been sold is above/below the target average discount. The OPP field stores an original purchase price of the product, before negotiation. For example, the price stored in the OPP field may be the price offered by the retailer 102 on the website of the retailer 102.

Each product may have zero or many entries in a Transactions table 303, while each transaction relates to a single product, therefore having one corresponding entry in the Products table 302. In particular, each time a product is sold through the facilitator 101 a corresponding transaction is recorded into the Transactions table 303. Each entry in the Transactions table 303 comprises a TransactionID field, a TransactionDate field and a PricePaid field. The TransactionID field uniquely identifies each transaction in the database 106. The TransactionDate field stores the date on which the transaction took place, while the PricePaid field stores the price paid by for the product during the transaction.

A Customers table 304 stores records for each customer 103. The Customer table 304 comprises a CustomerID field and a MembershipLvl field. The CustomerID field uniquely identifies each customer within the database 106, while the MembershipLvl field stores a membership level of the customer. Membership levels are discussed in further detail below. Each customer may have zero or more entries in a Negotiations table 305. Each record in the Negotiations table 305 stores data relating to a particular negotiation session between a customer 103 and a retailer 102 for a particular product in the Products table 302. As such, it can be seen that each entry in the Products table 302 may have zero or more corresponding entries in the Negotiations table 305.

The Negotiations table 305 comprises a session ID field uniquely identifying a session within the database 106, a BidCntr field indicating the number of bids that have been placed by the customer participating in that negotiation session, and a CurrentBid field, identifying the value of the last, and therefore current, bid placed by the customer participating in the negotiation session. A CurrentOffer field stores data indicating the value of the last, and therefore current, offer made in response to the last bid. A Current field stores a Boolean value indicating whether an entry in the Negotiations table 305 relates to an ongoing (i.e. current) negotiation, or a ceased (i.e. historical) negotiation.

Each negotiation session may have one to five bids, details of which are stored in a Bids table 306. Each entry in the Bids table 306 comprises a bid ID field, and BidSeqNo field, a BED field, a BidPrice field and a BidTimeStamp field. The BidID field uniquely identifies each bid within the database 106. The BidSeqNo field identifies the position of the bid in the sequence of bids for a particular negotiation session. As each negotiation session can have one to five bids, the BidSeqNo field may take a value of one to five depending upon whether the entry relates to a first, second, third, fourth, or fifth bid in the negotiation session. It will be appreciated that the BidCntr field of the Negotiations table 305 will store the same value as the BidSeqNo field of the Bids table 306. The BED field stores a date at which the bid is no longer extant (i.e. a bid expiry date). The BidPrice field stores the value of the amount that the customer has offered in the bid. The BidTimeStamp field stores the date and time the bid was entered into the system for audit and processing purposes.

Each negotiation session, may also have one to six offers (the first of which will be the Original Product Price), details of which are recorded in an Offers table 307. Each entry in the Offers table 307 is a “response” to an entry in the Bids table 306. The Offers table 307 comprises an OfferID field, an OED field, and an OfferPrice field. The OfferID field uniquely identifies the offer within the database 106. The OED field stores a date at which the offer is no longer extant (i.e. an offer expiry date). The OfferPrice field stores the price that has been offered in response to the value of the BidPrice field of the corresponding entry in the Bids table 306.

Each transaction recorded in the Transactions table 303, has one negotiation session recorded in the Negotiations table 305, while each negotiation session recorded in the Negotiations table 305 may have zero to one transactions recorded in the Transactions table 303. That is, when a negotiation session completes, that negotiation session is associated with a transaction. While a negotiation session is ongoing, such that a transaction has not yet taken place, no transaction exists for the negotiation session. If a negotiations session does not result in a transaction, no entry is recorded in the Transactions table 303 for that negotiation session.

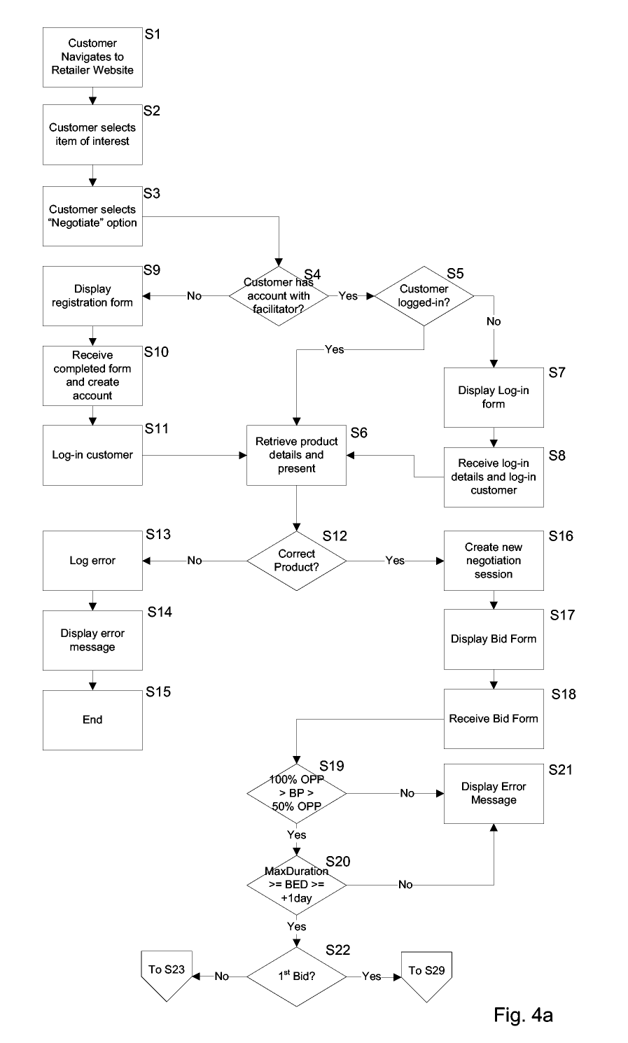

With reference to FIGS. 4a and 4b, there is now described processing carried out at the facilitator 101 in order to implement a negotiation session between one of the customers 103 and one of the retailers 102. It is to be appreciated that in some embodiments of the present invention, the processing described with reference to FIGS. 4a and 4b is implemented by the retailers 102, rather than through a third party such as the facilitator 101.

Prior to the processing described with reference to FIG. 4, it is to be understood that the retailer 102 provides the facilitator 101 with data relating to products that the retailer 102 wishes to be eligible for price negotiation through the facilitator 101. In particular, the retailer 102 provides data including the maximum discount for each product, a target average discount and a target maximum discount, as discussed above with reference to FIG. 3. That is, the retailer uploads sufficient information to populate the entries in tables 301 and 302 of the database. It will be appreciated that retailer 102 may provide this information to the facilitator 101 periodically. For example, the retailer 102 may provide this information daily.

Referring to FIG. 4a, at step S1 a customer 103 navigates to a website of a retailer 102. At step S2, the customer 103 identifies a product on the website of the retailer 102 which the customer 103 may wish to purchase. By selecting, at step S3, an option (which may be provided, for example, in the form of a button or a link provided on the retailer's website) to go to the facilitator 101, the consumer 103 indicates that he is not willing to pay the price advertised on the website of the retailer 103, but is interested in negotiating with the retailer 103 to settle on a mutually acceptable price for the product. Selection of the negotiation option on the website of the retailer 102 causes data indicating the product of interest to be sent to the facilitator 101 to allow the facilitator to begin a negotiation session for the product. It will, of course, be appreciated that in alternative embodiments of the present invention, customers 102 may select products directly from the website of the facilitator 101.

From Step 3, processing passes to step S4, at which it is determined whether the customer has registered an account with the facilitator 101. For example, a web page may be served to the customer 103 at step S4, the web page comprising an enquiry as to whether the customer 103 already has an account with the facilitator 101, or whether he would like to open a new account. If it is determined that the customer 103 has already registered an account with the facilitator 101 (for example the customer 103 selects an option indicating that he already has an account), processing passes to step S5, at which it is determined whether the customer 103 is currently “logged-in” to his account. If it is determined that the customer 103 is currently logged in to his account with the facilitator 101, processing passes from step S5 to step S6, at which the customer 103 is presented with product details (e.g. product name, image, purchase price offered on the website of the retailer 102, etc) retrieved from the database 106 (based on the product details received from the website of the retailer 103 at step S3) together with a request to confirm that the retrieved product details match the product identified by the customer 103 on the website of the retailer 102. That is, the processing at step S6 aims to confirm that the details held by the facilitator 101 in the database 106 for a particular product are the same as those advertised on the website of the retailer 102.

If, on the other hand, it is determined at step S5 that the customer 103 is not currently logged-in to his account with the facilitator 101, processing passes to step S7, at which the customer is presented with a log-in form, thereby allowing the customer 102 to log-in to their account with the facilitator 101 at step S8. Any appropriate log-in mechanism may be used, such log-in mechanisms being well known in the art. Processing passes from step S8 to step S6.

If, at step S4, it is determined that the customer 103 does not have an account with the facilitator 101, processing passes to step S9, at which the customer 103 is presented with a registration form to allow the customer 103 to create an account with the facilitator 101. The completed registration form is received, and an account for the customer 103 created, at step S10. The data obtained from the customer 103 at S10 is used to populate the customer table 304 with the database 106 from step S10 to S11 at which the customer 103 is logged-in to their newly created account with the facilitator 101. Processing passes from step S11 to step S6.

From step S6, processing passes to step S12, at which it is determined whether the customer 103 has confirmed or denied that the product details retrieved from the facilitator database 106 are the same as those identified by the customer 103 on the website of the retailer 102. If it is determined at step S12 that the product retrieved from the database 106 is not the same as the product identified by the customer 103 on the website of the retailer 102, processing passes to step S13 at which an error report is generated to indicate an inconsistency between the product displayed on the website of the retailer 102 from which the customer 103 arrived at the website of the facilitator 101 and the product details stored in the database 106.

From step S13, processing passes to step S14 at which a suitable error message is displayed to the customer 103. Processing passes from step S14 to end at Step 15. It will be appreciated, that the error report generated at step S13 allows an administrator of the website of the facilitator 101 to review the link between the product stored in the database 106 corresponding to the web address from which the customer arrived from the website of the retailer 102 in order to correct any inconsistencies.

If, on the other hand, it is determined at step S12 that the product details retrieved from the database 106 do correspond to the product identified by the customer 103 on the website of the retailer 102, processing passes from step S12 to step S16, at which a negotiation session 305 is created having a corresponding entry in the Negotiations table 305. It will be appreciated that at this stage, no bids have been received, nor offers presented, to the customer 103 such that the newly created negotiation session does not comprise any bids or offers. From step S16 processing passes to step S17 at which a “bid form” is presented to the customer 103. The bid form presented at step S17 allows the customer 103 to enter a bid price for the product together with a bid expiry date.

Processing passes from step S17 to step S18 at which a completed bid form is received from the customer 103. At step S19 it is determined whether the bid price is greater than 50% of the original purchase price (that is the price advertised on the web site of the retailer 102) and less than 100% of the original purchase price. If it is determined that the bid price is greater than 50% and less than 100% of the original purchase price processing passes to step S20 at which it is determined whether the bid expiry date is greater than or equal to one day from the current date and less than or equal to ten days from the current date. If it is determined at step S19 that the bid price is not greater than 50% or less than 100% of the original purchase price, or it is determined at step S20 that the bid expiry date is not greater than or equal to one day or less than or equal to ten days from the current date and time, processing passes from either step S19 or step S20 respectively to step S21 at which an appropriate error message is displayed to the customer. For example, an error message may be displayed asking the customer to re-enter a bid which meets the requirements of steps S19 and S20.

If the requirements of steps S19 and S20 are met, processing passes from step S20 to step 22. It is determined whether the customer is initiating the negotiation with the bid received at step S18. That is, it is determined at step S22 whether the bid received at step S18 is the first bid for the negotiation session. If it determined at step S22 that the customer 103 is not initiating negotiation with the bid received at step S18 (i.e. the bid received at step S18 is not the first bid in the sequence of bids for the negotiation session), processing passes to step S23 (FIG. 4b). At step S23 it is determined whether at least one of the bid price or the bid expiry date received at step S18 are different from the bid price or bid expiry date of the previous bid in the sequence of bids for the negotiation session. For example, if the previous bid to be received was the second bid for the negotiation session, the bid price and bid expiry date of the bid received at step S18 are compared with the bid price and bid expiry date of the previously received second bid of the negotiation session.

If it is determined at step S23 that the bid price or the bid expiry date are different to the bid price or bid expiry date of the previous bid, processing passes from step S23 to step S24 at which it is determined whether the customer 103 has been provided with a corresponding offer for the previously received bid (i.e. the bid received prior to the bid received at step S18). For example, again assuming that the previously received bid is the second bid, it is determined at step S24 whether the customer 103 has received a second offer. If it is determined at step S24 that the customer 103 has received an offer in response to the previously received bid, this indicates that the bid received at step S18 is a response to the previously received offer. Processing therefore passes from step S24 to step S25 at which a new bid is created based on the details received at step S18, and the bid counter field of the current negotiation is incremented by one.

Processing passes from step S25 to step S26 at which it is determined whether the bid created at step S25 is the fifth bid in the sequence of bids for the negotiation session. If it is determined at step S26 that the bid created at step S25 is the fifth bid in the sequence of bids for the negotiation session, processing passes to step S27 at which a change bid option is deactivated for the negotiation session. For example, on a web page usable by the customer 103 to manage the negotiation session, a button allowing the customer 103 to change his bid may be removed or deactivated. Processing passes from step S27 to step S28. If, on the other hand, it is determined at step S26 that the bid created at step S25 is not the fifth bid in the sequence of bids for the negotiation session, processing passes from step S26 to step S28. At step S28, receipt of the bid is acknowledged to the customer 103. For example, at step S28 an email may be sent to the customer 103 acknowledging receipt of the bid.

If, on the other hand, it is determined at step S22 (FIG. 4a), that the customer 103 is initiating the negotiation with the bid details received at step S18, processing passes from step S22 to step S29 (FIG. 4b) at which a new (first) bid is created and bid counter of the negotiation session is incremented by one. Processing passes from step S29 to step S28.

Processing passes from step S28 to step S30 at which a new offer price, offer expiry date and offer reveal date are calculated in response to the bid created at step S25 or S29. The calculation of an offer price may vary depending upon plurality of criteria. As an example, a new offer price may be calculated by determining a random value between the bid price and the original purchase price of the product. In general, however, an algorithm used to calculate a new offer price may be based upon a weighted function incorporating one or more of the following variables: the bid price of the newly received bid, the time remaining before the bid expiry date of the newly received bid, the original purchase price of the product, a number of items of the product already sold, an average discount of the items of the product sold, the retailer's target average discount (for the product and/or across all products) and maximum discount allowed (for the product and/or across all products), values of previously received bid prices and offers, the position of the newly received bid in the sequence of bids for the negotiation session, customer specific demographic or behavioural information, and one or more randomising factors. For example, a suitable randomising factor may be based on a standard statistical distribution chosen to produce an average selling price to match that determined by the “Target Average Discount” dictated by the retailer

Further, it is to be understood that the variables described above are merely exemplary, and that a new offer price may be based upon any number of factors and any information stored in the database 106, or otherwise available to the facilitator 101. Indeed, the exact variables and algorithms used to calculate the offer price may vary between different retailers 102 and may vary temporally. That is, an algorithm used to calculate a new offer price at step S30 for one retailer 102 at one time may be different to an algorithm used to calculate a new offer price at step S30 for the same retailer at a different time. By varying the algorithm used at step S30 to calculate a new offer price, an effect of negotiating with the retailer 102 may be accurately provided.

Similarly, it is to be appreciated that the algorithms used to calculate the offer expiry date and offer reveal date may vary between retailers and may vary temporally. As an example, the offer reveal date may be calculated by selecting a random date and time between the current date and time and the bid expiry date. In general, however, the offer reveal date and offer expiry date may be calculated based upon the same or similar factors used to calculate the offer price as described above. Depending upon which is calculated first, the calculations for the offer price, offer expiry date, and offer reveal date may incorporate the newly calculated offer price, offer expiry date and/or offer release date into their respective calculations.

In some embodiments of the invention, the offer price, offer reveal date and offer expiry date may be increased or decreased based upon a determined patience/eagerness of the customer 103. That is, for example, if the customer 103 provides a relatively short bid expiry date at step S18 of FIG. 4a, this may indicate that the customer 103 is relatively eager to purchase the product and is therefore unwilling to wait and barter for more favourable offer prices. Conversely, a relatively distant bid expiry date may indicate that the customer 103 is willing to wait for lower prices to be offered. A measure of the patience of the customer 103 may be determined by other means. For example, a customer's patience may be indicated by a speed with which responses to offer prices are received from the customer.

The calculation of the offer price, offer expiry date and offer reveal date may additionally take into account information from past negotiations involving the particular one of the customers 103 currently negotiating, and may additionally take into account information from past negotiations of other customers 103. For example, in some embodiments of the present invention, the processing of step S30 may be performed using artificial intelligence techniques. For example, each of the variables discussed above may be provided as inputs to one or more neural networks trained to provide a price which is expected to be accepted. Data for training such neural networks may be compiled from data provided by the retailers 102, or from negotiations and/or purchases made through the facilitator 101. It will be appreciated that any appropriate neural network may be used, for example a multi-layer perceptron. It will further be appreciated that other artificial intelligence approaches and tools may be used.

The calculation of the offer price, offer expiry date and offer reveal date may additionally take into account information from external sources. For example, the system may have access to popular “blog” sites, transcripts of current TV broadcasts, regional weather forecasts and/or sports results. By ‘scraping’ these sites and documents and by carrying out keyword searches the system may judge which products are being ‘blogged’ about favourably/unfavourably or are being shown on TV in a positive/negative light. The system might use sports results to predict demand for sporting goods or weather forecasts to anticipate demand for items such as raincoats or barbeques. This information might be used to adjust offer prices shown to customers or to bring forward offer reveal/expiry dates in real time without the need for overt re-pricing and without knowledge of these changes being widely available to competitors.

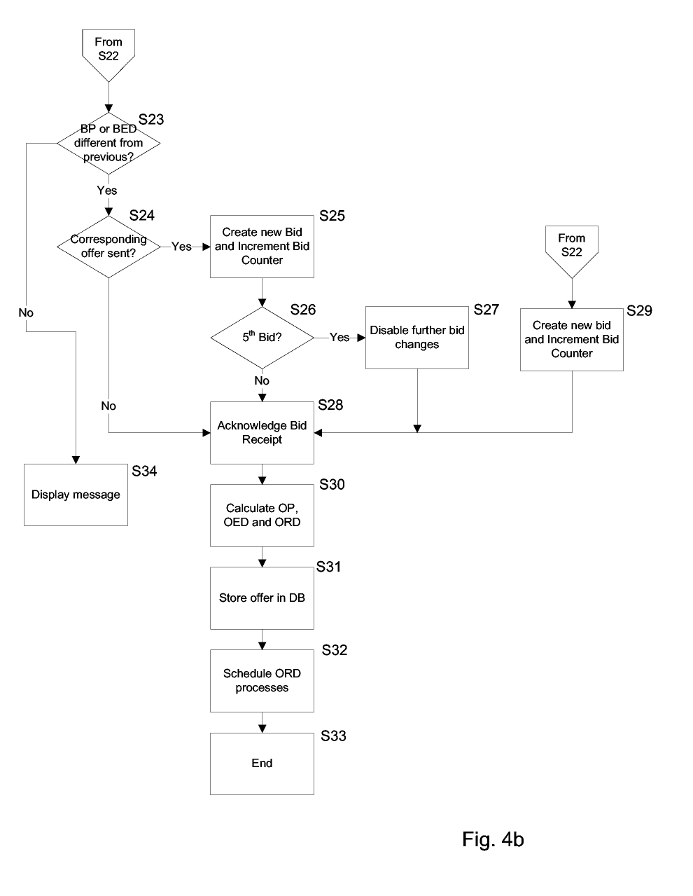

Processing passes from step S30 to step S31 at which the new offer is recorded in the database 106. Processing passes from step S31 to step S32 at which processing to be carried out by the facilitator on the offer reveal date is scheduled. For example, any suitable scheduling system may be used at step S32. For example, in Unix-based systems, Cron may be used to schedule operations to be performed on the offer reveal date. Processing carried out at the offer reveal date is described below with reference to FIG. 5. Processing passes from step S32 to end at step S33.

Returning to step S23, if it is determined that neither the bid price, nor the bid expiry date received at step S18 differ from the bid price or bid expiry date of the last received bid, processing passes to step S34 at which a suitable message is displayed to the customer 103, for example acknowledging receipt of the bid, or informing the customer 103 that the bid has already been received and that they will receive a response shortly.

If, at step S24, it is determined that an offer has not yet been made for the previous bid, processing passes directly from step S24 to step S28. In this way, a bid may be altered before a corresponding offer has been received. That is, if the customer has not yet received an offer corresponding to the customer's previously submitted bid, the customer is able to modify the previously submitted bid without incrementing the bid counter for the negotiation session.

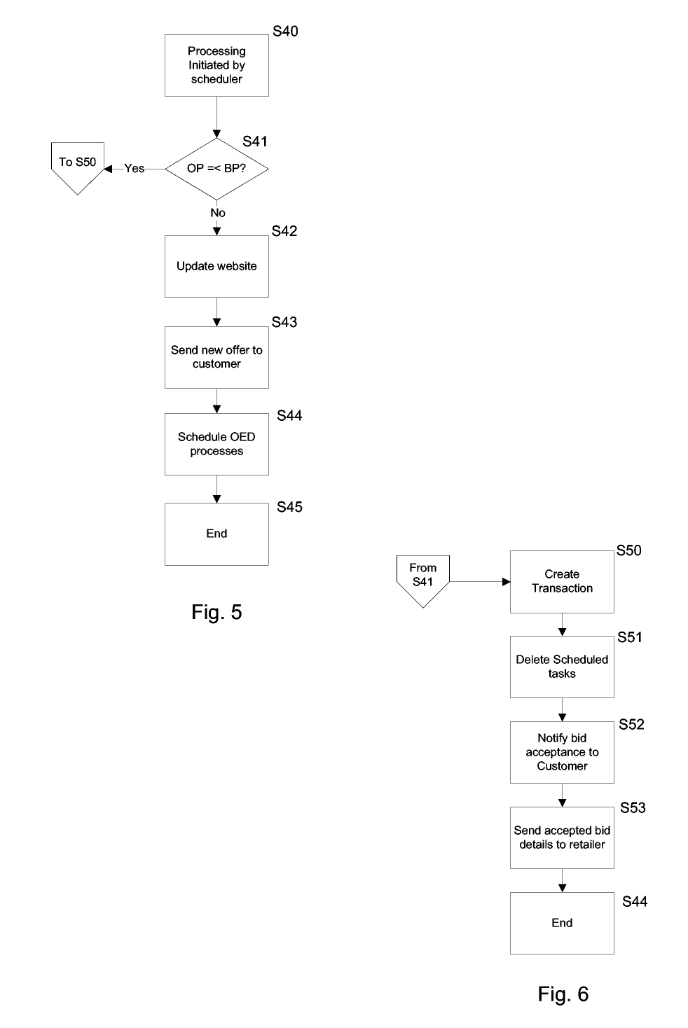

Referring now to FIG. 5, there is described processing carried out by the facilitator 101 at the offer reveal date calculated at step S30 of FIG. 4b. At a step S40, the scheduler (e.g. Cron) initiates the processing of FIG. 5. Processing passes from step S40 to step S41 at which it is determined whether the offer price calculated at step S30 of FIG. 4b is less than, or equal to, the bid price of the bid received at step S18 of FIG. 4a. If it is determined that the offer price is less than or equal to the bid price, processing passes to step S50 (FIG. 6) at which a sale process is begun. The sale process is described in more detail below with reference to FIG. 6. That is, if the offer price is less than or equal to the bid price, there is no need to present a new offer to the customer 103. Rather, the bid price offered by the customer at step S18 of FIG. 4a is accepted, thereby ending the negotiation session and allowing the product to be purchased for the current bid price.

If, on the other hand, it is determined at step S41 that the offer price calculated at step S30 of FIG. 4b is not less than or equal to the bid price received at step S18 of FIG. 4a, processing passes to step S42, at which the website of the facilitator 101 is updated to reflect the new offer price and offer expiry date. For example, a web page usable by the customer 103 to manage the negotiation session may be updated to display the new offer price and the offer expiry date. Processing passes from step S42 to step S43 at which the customer 103 is notified of the new offer price and the offer expiry date. For example, an email may be sent to the customer at step S43, although it will be appreciated that any means of notifying the customer 103 of the new offer may be employed. Processing passes from step S43 to S44 at which processing, to be undertaken during the period up to and including the offer expiry date, is scheduled. For example, processing may be scheduled to notify a customer one hour before the offer expiry date (for example via email), and to replace the offer price with the original purchase price on the offer expiry date. The processing of FIG. 5 proceeds from step S44 to end at step S45.

Processing carried out by the facilitator 101 to conclude a negotiation session with a successful sale is now described with reference to the flow chart of FIG. 6. At step S50 an entry is created in the transactions table for the current negotiation session. Processing passes from step S50 to step S51 at which any tasks which have been scheduled in relation to the current negotiation session are deleted. For example, where a customer 103, having submitted a bid, subsequently accepts a previous offer price before receiving a new offer price, a task may exist to email the customer on the offer reveal date. Other scheduled tasks which may exist for a negotiation session include sending reminder emails before the offer expiry date, updating the web page of the facilitator to display a new offer price and offer expiry date, sending a reminder that a bid is shortly to expire, and a withdrawal of a bid at a corresponding bid expiry date. Processing passes from step S51 to step S52 at which the customer is notified of the successful completion of the purchase and the end of the negotiation session. Processing passes from step S52 to step S53 at which customer details and the details of the accepted bid are transmitted to the retailer 103 so that the retailer 103 can complete the transaction and dispatch the product to the customer. Processing of FIG. 6 ends at step S44.

It will be appreciated that the exact manner in which a purchase is completed may vary. For example, payment may occur through a website of the facilitator 101, or through a website of the retailer 102.

As described above with reference to step S51 of FIG. 6, a user may be able to undertake certain actions during the period between a new offer being generated and the corresponding offer reveal date. For example, during this period the customer 103 may accept a previous offer, or where no offer has yet been presented, may accept the original purchase price. In these cases, the processing of FIG. 6 would be initiated. Alternatively, a customer may select an option to change a previously submitted bid before receiving a corresponding offer. In this case, the processing of FIG. 4a initiates from step S17 and proceeds as described above with reference to FIGS. 4a, 4b. Alternatively, a user may select an option to withdraw their bid thereby ending the negotiation session. In this case, the database 106 is updated to indicate that the negotiation session has concluded without a purchase, and any tasks scheduled in connection with the negotiation session are deleted.

The processing described above with reference to FIGS. 4, 5, 6 allows a retailer 102 to provide a seemingly personal negotiation with each customer 103, without requiring the significant investments in trained staff and time, that would be required to provide each customer with personal responses to bids made by those customers. For example, by revealing offers only on offer release dates, calculated based upon the factors described above, instead of displaying a calculated offer immediately, the processing of FIGS. 4 to 6 provides the effect that each customer's bid is being considered. This effect is further enhanced by the use of randomising factors in addition to other factors as described above, in the calculation of offer prices, offer reveal dates and offer expiry dates, to provide seemingly personal offers.

Further, by revealing offers to customers 103 only on offer release dates, calculated based upon the factors described above, instead of displaying a calculated offer immediately, the processing of FIGS. 4 to 6 serves to differentiate between customers 103 based on their ‘eagerness’ to purchase products for which the customers 103 are negotiating. Put another way, the processing of FIGS. 4 to 6 provides a ‘differential pricing’ mechanism into which the customers 103 self-select.

With reference to FIG. 3, in some embodiments of the invention, the Offers table 307 may additionally comprise an Availability field indicating a number of items of a product available to purchase at the offer price of each offer. For example, as the negotiation progresses, and offers become cheaper, fewer items of the product may be offered.

As described with reference to FIG. 3, the Customers table 304 contains a MembershipLvl field. In some embodiments of the invention, a customer's membership level may be used in the calculation of offer price, offer reveal date and/or offer expiry date described above with reference to FIGS. 4a, 4b. A customer 103 may increase their membership level via any appropriate mechanism. For example, membership levels may be increased through advertising the facilitator 101 (e.g. by placement of ads on personal pages of social networking websites), or through purchasing of products through the facilitator 101.

Furthermore, in some embodiments of the invention, a customer's membership level may be used to give that customer immediate access to those offers that have been negotiated by other customers 103. For example, a “Gold” member may be given direct access (i.e. without needing to “negotiate”) to some or all extant 5^{th} offers (i.e. final offers which are still available for acceptance by the customer 103 participating in the negotiation in which the offer was made) made by the facilitator 101. “Platinum” members may be given direct access to all extant 4^{th} and 5^{th} offers that have been made by the facilitator 101. Additionally, or alternatively Gold members may be given direct access to some or all currently extant offers made by the facilitator 101 once a predetermined time period (for example, three hours) has elapsed since the offer reveal date of those offers. Platinum members may be given direct access to some or all currently extant offers after a shorter period of time (for example, two hours). In this way, other customers 103, not directly involved in a negotiation for a product, may be provided with an opportunity to purchase a product, at an offer price that another customer 103 has negotiated. Such opportunities may be provided directly through the website of the facilitator 101.

In some embodiments, where extant offers are made available to other customers 103 not engaged directly in the negotiation from which those offers have arisen, a number of units of a product available for purchase by the customer 103 who instigated the negotiation in which the offer was made, will be seen by that customer 103 to decline as other customers 103 make purchases at the offer prices made available as the negotiation progresses. In this way the original customer 103 is incentivised to pay close attention to notifications of offers sent by the facilitator 101 and to act expeditiously in dealing with those offers.

While it is described above that a negotiation takes place with a single customer 103, in other embodiments of the present invention negotiations may be based upon bids received from a plurality of customers 103 who wish to purchase a particular product. In this case, calculation of offer prices, offer release dates, and offer expiry dates may be at least partially based upon a function of bids received from respective customers 103 for a particular product.

It is known for e-commerce websites to make subtle changes to their prices using sophisticated pricing engines. Such pricing engines automatically search Internet web pages to determine prices offered by other retailers, so that the best prices offered by other retailers can be undercut by small margins. By having prices amongst the lowest for a particular product, a retailer will appear at the top of web search results for that product.

Embodiments of the present invention, however, allow the option of prices to be provided only to customers engaged in negotiations. For example, where offer prices are displayed to customers 103 only via secure web pages on the website of the facilitator 101, these prices can be withheld from rival retailers. In this way, a retailer 102, using the present invention, can, for example, engage in price promotions without drawing the attention of rivals and thus diluting the effect of their promotion by precipitating ‘race to the bottom’ ‘price wars’ that might undermine the effect of their promotion and could cause long term damage to their margins. It is also the case that a retailer 102, using the present invention, can himself match or beat competitors' prices, however, he can accomplish this without those competitors becoming aware of his activity in this regard.

In some embodiments of the present invention, prices paid by customers 103 may be published by a retailer 102 after a transaction completes. In this way, where particularly low prices have been achieved during negotiation, these prices may act as advertisements for other customers 103. However, as the data regarding the eventual sale price is no longer extant, and likely represents a relatively rare offer, such data is of limited use to competitors wishing to undercut the price offered by the retailer 102.

Further, embodiments of the present invention allow the retailers 103 to determine a “depth of market” based upon information collected during negotiations. That is, even “unsuccessful” negotiations (i.e. those which do not result in eventual purchase by a customer 103) provide information about a price at which the customer 103 would have been willing to purchase the product. In this way, valuable information may be provided to the retailer 102 indicating pricing strategies for generating the greatest demand, allowing the retailers 102 to adjust their prices to generate maximum revenue.

Throughout the processing performed by the facilitator 101, described above, data is recorded in the database 106 to allow for complete auditing of all interactions between the customer 103 and the facilitator 101, and between the retailer 102 and the facilitator 101. For example, while not illustrated for clarity, various fields in the tables of the database 106 may comprise associated fields for recording auditing information. For example, “timestamp” fields may be associated with various other fields to record times and/or dates on which particular events occurred. For example, where a customer makes, changes, or withdraws a bid, data may be recorded indicating the times and dates on which these events took place. It will be appreciated that any field of any table in the database may have a corresponding auditing fields to record details of events associated with the data recorded by those fields. Such recordal of information at each stage of the process has benefits in addition to auditing. In particular, as described above, the present invention may provide prediction of future customer behaviour based on historical customer behaviour, other customers' behaviour and/or external information. By recording data at each stage of the transaction process, the facilitator 101 is provided with deeper and more accurate information on which to base decisions, such as offer price, offer reveal date, and offer expiry date calculations.

It is to be understood that while, in the example embodiments described above, the facilitator 101 is a separate entity to the retailers 102, in some embodiments of the present invention, the retailers 103 may provide options to negotiate with customers directly. That is, in some embodiments of the present invention, the processing described above as being performed by the facilitator 101 may be performed at the retailers 102 directly.

It will be appreciated that embodiments described above are merely exemplary and that modifications may be made to the embodiments described above without departing from the spirit or scope of the appended claims. For example, while it is indicated that each customer may receive five bids during a negotiation session, it will be readily apparent from the teaching herein that negotiations may comprise more of fewer bids (and more or fewer counter-offers). Further, while it is described with reference to FIGS. 4a, 4b that offers are received in response to bids from customers 103, it will be appreciated that offers may be made by the facilitator 101 prior to bids being received from customers.

1. A computer implemented method of facilitating transactions between a first party and a second party, comprising:
receiving from the first party a first indication of interest in a transaction subject;
generating, in response to receiving said first indication of interest a first response and a response reveal date; and
transmitting said first response to said first party on or after said response reveal date.

2. A method according to claim 1, wherein said response reveal date is generated using one or more artificial intelligence techniques.

3. A method according to claim 1, wherein said response reveal date is generated using a neural network.

4. A method according to claim 1, wherein generating said response reveal date comprises applying a randomising factor.

5. A method according to claim 1, wherein said response reveal date is generated based upon first transaction criteria associated with said transaction subject, said first transaction criteria comprising at least one of a maximum discount to be applied to said transaction subject, a target average discount to be applied to said transaction subject, a maximum discount to be applied across a plurality of transaction subjects, and a target discount to be applied across said plurality of transaction subjects.

6. A method according to claim 1, wherein said first indication of interest comprises a first bid, said first bid comprising a bid price; and
wherein said response reveal date is generated based upon said bid price.

7. A method according to claim 1, wherein generating said response reveal date further comprises generating a response reveal date based upon at least one of: a bid price received from said first party, a bid expiry date received from said first party, an original price of the transaction subject, a number of items of the transaction product sold in prior transactions, an average discount applied to items of the transaction subject in prior transactions, a maximum discount to be applied to the transaction subject, a maximum average discount to be applied to a plurality of transaction subjects, values of previously received bid prices, values of previously generated offer prices, a number of previously received bid prices from the first party for the transaction subject, information acquired from parties not engaged in said transaction, and one or more randomising factors.

8. A method according to claim 1, wherein generating a response reveal date further comprises providing at least one of: a bid price received from said first party, a bid expiry date received from said first party, an original price of the transaction subject, a number of items of the transaction product sold in prior transactions, an average discount applied to items of the transaction subject in prior transactions, a maximum discount to be applied to the transaction subject, a maximum average discount to be applied to a plurality of transaction subjects, values of previously received bid prices, values of previously generated offer prices, a number of previously received bid prices from the first party for the transaction subject, information acquired from parties not engaged in said transaction, and one or more randomising factors as inputs to a neural network.

9. A method according to claim 1, wherein said first indication of interest comprises a bid price and said first response comprises an indication of acceptance of the bid price.

10. A method according to claim 1, wherein said first indication of interest comprises a bid price, and said first response comprises an indication of rejection of the bid price.

11. A method according to claim 1, further comprising receiving a respective first indication of interest in said transaction subject from each one of a plurality of first parties, each of said respective indications of interest comprising a respective bid price; and
processing said received bid prices to generate a depth of market indication.

12. A method according to claim 1, wherein transmitting said first response to said first party on or after said response reveal date comprises transmitting said indication over a secure medium.

13. A method according to claim 12, wherein said secure medium is inaccessible by indexing mechanisms of network search engines.

14. A method according to claim 1, wherein said first indication of interest comprises a bid and the method further comprises:
determining whether a predetermined number of bids have been received for said transaction subject from said first party; and
if it is determined that predetermined number of bids have been received for said transaction subject from said first party, disallowing receipt of further bids for said transaction subject from said first party.

15. A method according to claim 1, wherein transmitting said first response to said first party comprises transmitting an indication of a number of items of said transaction subject available for purchase by said first party at an offer price.

16. A method according to claim 15, further comprising reducing said number of items available for purchase by said first party at said offer price upon purchase of an item of said transaction subject by a third party at said offer price; and
providing an indication of said reduced number of items to said first party.

17. A method according to claim 1, further comprising in response to receiving said indication of interest, reducing a previously available number of items of said transaction subject available for purchase by said first party; and
wherein said first response comprises an indication of said reduced number of items of said transaction subject available for purchase by said first party.

18. A method according to claim 1, wherein said receiving, generating and transmitting are carried out at a third party, distinct from said second party.

19. A method according to claim 18, wherein said transaction criteria are received at said third party from said second party.

20. A computer implemented method for facilitating transactions between a first computer and a second computer, comprising:
receiving over a first network from the first computer a first indication of interest in a transaction subject;
generating a response and a response reveal date; and
transmitting said response over the first network to said first computer on or after said response reveal date.

21. A method according to claim 20, wherein said receiving, generating and transmitting are performed by a third computer distinct from said second computer.

22. A computer program comprising computer readable instructions configured to cause a computer to carry out a method according to claim 1.

23. A non-transitory computer readable medium carrying a computer program according to claim 22.

24. A computer apparatus for facilitating transactions between a first computer and a second computer comprising:
a memory storing processor readable instructions; and
a processor arranged to read and execute instructions stored in said memory; wherein said processor readable instructions comprise instructions arranged to control the computer to carry out a method according to claim 1.

25. A system for facilitating transactions between a first computer and a second computer, comprising:
a receiver arranged to receive over a first network from the first computer a first indication of interest in a transaction subject;
a processor arranged to generate in response to receiving said first indication of interest a response and a response reveal date; and
a transmitter arranged to transmit said response over the first network to said first computer on or after said response reveal date.
